(19) United States
(12) Patent Application Publication
(10) Pub. No.: US 2024/0159453 A1
(43) Pub. Date: May 16, 2024

(54) REFRIGERATOR

(71) Applicant: SAMSUNG ELECTRONICS CO., LTD., Suwon-si (KR)

(72) Inventors: Hongrin KIM, Suwon-si (KR); Joongho KIM, Suwon-si (KR); Jeongman NAM, Suwon-si (KR); Younggon PARK, Suwon-si (KR)

(73) Assignee: SAMSUNG ELECTRONICS CO., LTD., Suwon-si (KR)

(21) Appl. No.: 18/236,774

(22) Filed: Aug. 22, 2023

Related U.S. Application Data
(63) Continuation of application No. PCT/KR2023/011602, filed on Aug. 7, 2023.

(30) Foreign Application Priority Data
Nov. 14, 2022 (KR) 10-2022-0151495

(51) Int. Cl. F25D 23/02

(52) U.S. Cl. CPC F25D 23/028; F25D 2201/10

(57) ABSTRACT

A refrigerator includes: a main body forming a storage chamber; a first door rotatably coupled to the main body to open and close at least a portion of the storage chamber; a second door adjacent to the first door and rotatably coupled to the main body to open and close at least another portion of the storage chamber; and a rotating bar rotatably coupled to the first door and configured to cover a gap between the first door and the second door when the first door and the second door are closed, wherein the rotating bar may include: a case; a case cover coupled to the case, the case cover and the case together forming an inner space; and a foamed heat insulator disposed in the inner space and couples the case and the case cover to each other.

### CROSS-REFERENCE TO RELATED APPLICATIONS

This application is a by-pass continuation of International Application No. PCT/KR2023/011602, filed on Aug. 7, 2023, which is based on and claims priority to Korean Patent Application No. 10-2022-0151495, filed on Nov. 14, 2022 in the Korean Intellectual Property Office, the disclosures of which are incorporated herein by reference.

### BACKGROUND

### 1. Field

The disclosure relates to a refrigerator, and more specifically, to a refrigerator including a rotating bar.

### 2. Description of Related Art

A refrigerator is an appliance that is equipped with a main body having a storage chamber, a cold air supply device for supplying the storage chamber with cold air, and a door for opening and closing the storage chamber to store food in a fresh state.

A storage chamber may be provided to store food. The storage chamber is opened and closed by a door. When the door is opened, cold air inside the storage chamber is discharged to the outside and warm air outside the storage chamber is introduced into the storage chamber, and thus the temperature of the storage chamber may rise.

On the other hand, a French Door Refrigerator (FDR)-type refrigerator includes a rotating bar rotatably coupled to a left door or a right door to prevent the outflow of cold air through a gap between the left door and the right door.

### SUMMARY

Provided is a refrigerator including a rotating bar that is pre-fabricated and allows foaming of a foaming liquid therein to form a heat insulator.

In addition, provided is a refrigerator including a rotating bar that is pre-fabricated and allows injection of a foaming liquid thereinto without the foaming liquid from flowing into a hinge member.

Additional aspects will be set forth in part in the description which follows and, in part, will be apparent from the description, or may be learned by practice of the presented embodiments.

According to an aspect of the disclosure, a refrigerator includes: a main body forming a storage chamber; a first door rotatably coupled to the main body to open and close at least a portion of the storage chamber; a second door adjacent to the first door and rotatably coupled to the main body to open and close at least another portion of the storage chamber; and a rotating bar rotatably coupled to the first door and configured to cover a gap between the first door and the second door when the first door and the second door are closed, wherein the rotating bar may include: a case; a case cover coupled to the case, the case cover and the case together forming an inner space; and a foamed heat insulator disposed in the inner space and couples the case and the case cover to each other.

The case may include an injection hole provided on a lower surface of the case and configured to receive a foaming liquid that is injected therein to form the foamed heat insulator.

The rotating bar may further include a hinge member, the hinge member may include a door coupling portion coupled to the first door and a shaft portion rotatably coupled to the case, the rotating bar is rotatably coupled to the first door via the hinge member, and the case may include a first fixing protrusion and a second fixing protrusion, the shaft portion is coupled to the first fixing protrusion and the second fixing protrusion, and a gap is formed between the first fixing protrusion and the second fixing protrusion.

The gap may be smaller than a diameter of the shaft portion, and the hinge member may be coupled to the case as the shaft portion passes through the gap by deforming the first fixing protrusion and the second fixing protrusion.

The case may further include a hinge partition wall protruding from the case toward the case cover and configured to partition the inner space, and the rotating bar may further include a hinge cover coupled to the hinge partition wall to form a hinge accommodating portion that accommodates the hinge member.

The hinge cover may include: a first protrusion protruding toward the hinge partition wall; a second protrusion protruding toward the hinge partition wall; and a cover groove between the first protrusion and the second protrusion, the hinge partition wall is accommodated in the cover groove, the foamed heat insulator is introduced into the inner space as a foaming liquid, and the first protrusion, the hinge partition wall, and the second protrusion are configured to block the foaming liquid from flowing into the hinge accommodating portion.

The rotating bar may further include a cover plate formed of a metal material, the case cover may include: a plate coupling portion; a coupling protrusion on the plate coupling portion; and a support rib spaced apart from the coupling protrusion and configured to support the cover plate, and the cover plate is seated in the plate coupling portion.

The cover plate may further include a protrusion accommodating portion which may include a protrusion accommodating hole, and the protrusion accommodating portion may protrude from the cover plate toward the case cover and the coupling protrusion is inserted into the protrusion accommodating hole.

A gap may exist between an inner edge of the protrusion accommodating hole and each of a first side end and a second side end of the coupling protrusion.

A gap may exist between an outer edge of the protrusion accommodating portion and the support rib.

The rotating bar may further include a guide protrusion protruding upward from an upper surface of the rotating bar, and the main body may include a guide groove configured to guide the guide protrusion during opening of the first door.

The rotating bar may further include a blocking rib protruding upward from an upper surface of the case and disposed apart from the guide protrusion, and the blocking rib may be configured to cover at least a portion of the guide groove to prevent discharge of air from the storage chamber through the guide groove.

A refrigerator includes: a first door; a second door; and a rotating bar rotatably coupled to the first door and configured to cover a gap between the first door and the second door when the first door and the second door are closed, wherein the rotating bar may include a case and a case cover together forming an inner space, and a foamed heat insulator disposed in the inner space, and the foamed heat insulator couples the case and the case cover to each other and is introduced into the inner space as a foaming liquid.

The rotating bar may further include a hinge member coupled to the first door, and the rotating bar may be rotatably coupled to the first door via the hinge member.

The rotating bar may further include: a hinge partition wall disposed in the inner space and configured to partition the inner space; and a hinge cover in the inner space and coupled to the hinge partition wall, the hinge partition wall and the hinge cover form a hinge accommodating portion, and the hinge member is disposed in the hinge accommodating portion.

The hinge accommodating portion may be configured to prevent the foaming liquid from entering the hinge accommodating portion when the foaming liquid is introduced into the inner space.

According to an aspect of the disclosure, a rotating bar of a refrigerator, includes: a case; a case cover coupled to the case, wherein the case and the case cover together form an inner space; a foamed heat insulator disposed within the inner space and configured to couple the case and the case cover to each other; and a hinge member configured to be rotatably coupled to a door of the refrigerator, wherein the foamed heat insulator is introduced into the inner space as a foaming liquid.

The rotating bar may further include: a hinge partition wall disposed within the inner space and configured to partition the inner space; and a hinge cover in the inner space and coupled to the hinge partition wall, the hinge partition wall and the hinge cover form a hinge accommodating portion, and the hinge member is disposed within the hinge accommodating portion.

The hinge accommodating portion may be configured to prevent the foaming liquid from entering the hinge accommodating portion when the foaming liquid is introduced into the inner space.

The hinge cover may include: a first protrusion protruding toward the hinge partition wall; a second protrusion protruding toward the hinge partition wall; and a cover groove formed between the first protrusion and the second protrusion to accommodate the hinge partition wall, and the hinge partition wall is accommodated in the cover groove, and wherein the first protrusion, the hinge partition wall, and the second protrusion are configured to block the foaming liquid from flowing into the hinge accommodating portion.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a perspective view illustrating a refrigerator according to an embodiment;

FIG. 2 is a side cross-sectional view schematically illustrating a refrigerator according to an embodiment;

FIG. 3 is a view illustrating a rotating bar of a refrigerator according to an embodiment;

FIG. 4 is a view illustrating the rotating bar shown in FIG. 3, when viewed at a different angle;

FIG. 5 is an exploded perspective view illustrating a rotating bar of a refrigerator according to an embodiment;

FIG. 6 is a view illustrating an inside of a lower portion of the rotating bar shown in FIG. 3;

FIG. 7 is an exploded view of the rotating bar shown in FIG. 6;

FIG. 8 is a view illustrating a process of coupling a lower hinge member to a case shown in FIG. 7;

FIG. 9 is a view illustrating a state in which a lower hinge member is coupled to a case shown in FIG. 7;

FIG. 10 is a view illustrating an inside of a middle portion of the rotating bar shown in FIG. 6;

FIG. 11 is a view illustrating the rotating bar shown in FIG. 10, when viewed from a different angle, in a state in which a wire cover member is separated from a case;

FIG. 12 is a view illustrating a process of coupling a wire cover member to the case shown in FIG. 11;

FIG. 13 is a view illustrating a state in which a wire cover member is coupled to the case shown in FIG. 11;

FIG. 14 is a view illustrating an inside of an upper portion of the rotating bar shown in FIG. 3;

FIG. 15 is an exploded view illustrating the rotating bar shown in FIG. 14;

FIG. 16 is a cross-sectional view taken along line A-A″ in FIG. 3;

FIG. 17 is a cross-sectional view taken along line B-B′ in FIG. 3;

FIG. 18 is a cross-sectional view taken along line C-C′ in FIG. 3;

FIG. 19 is a cross-sectional view taken along line D-D′ in FIG. 3;

FIG. 20 is a cross-sectional view taken along line E-E′ in FIG. 3; and

FIG. 21 is an exploded perspective view illustrating a rotating bar in a refrigerator according to an embodiment.

### DETAILED DESCRIPTION

Embodiments described in the specification and configurations shown in the accompanying drawings are merely examples of the disclosure, and various modifications may replace the embodiments and the drawings of the disclosure at the time of filing of the application.

Further, identical symbols or numbers in the drawings of the disclosure denote components or elements configured to perform substantially identical functions.

Further, terms used herein are only for the purpose of describing particular embodiments and are not intended to limit to the disclosure. The singular form is intended to include the plural form as well, unless the context clearly indicates otherwise. It should be further understood that the terms “include,” “including,” “have,” and/or “having” specify the presence of stated features, integers, steps, operations, elements, components, and/or groups thereof, but do not preclude the presence or addition of one or more other features, integers, steps, operations, elements, components, and/or groups thereof.

Further, it should be understood that, although the terms “first,” “second,” etc. may be used herein to describe various elements, the elements are not limited by the terms, and the terms are only used to distinguish one element from another. For example, a first element could be termed a second element, and similarly, a second element could be termed a first element without departing from the scope of the disclosure. The term “and/or” includes combinations of one or all of a plurality of associated listed items.

Herein, the expression “at least one of a, b or c” indicates “only a,” “only b,” “only c,” “both a and b,” “both a and c,” “both b and c,” or “all of a, b, and c.”

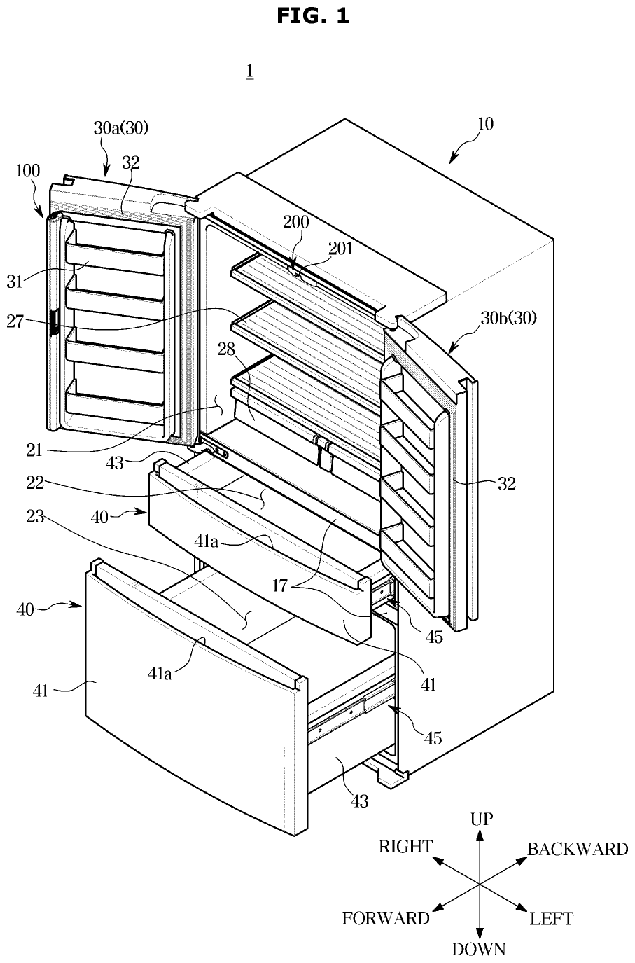

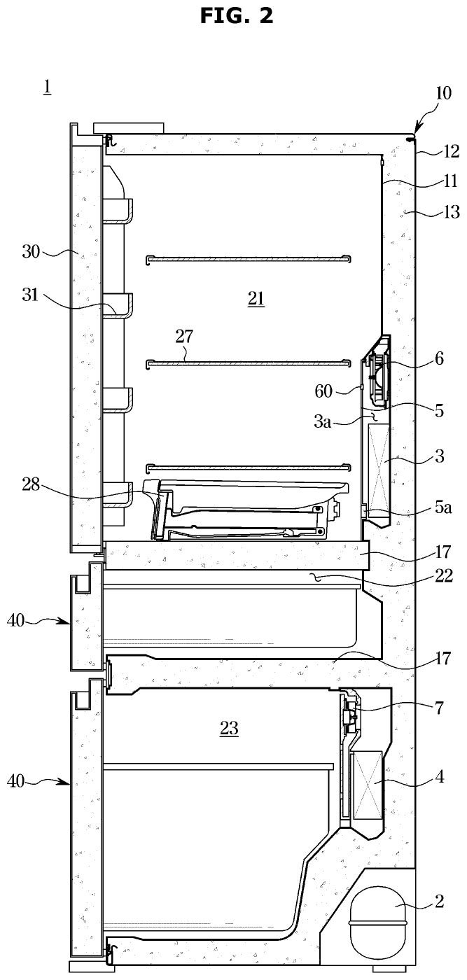

FIG. 1 is a perspective view illustrating a refrigerator according to an embodiment. FIG. 2 is a side cross-sectional view schematically illustrating a refrigerator according to an embodiment.

Referring to FIGS. 1 and 2, a refrigerator 1 may include a main body 10 having storage chambers 21, 22, and 23, and doors 30 and 40 provided to open and close the storage chambers 21, 22, and 23, and a cold air supply device for supplying cold air to the storage chambers 21, 22, and 23.

The main body 10 may include an inner case 11 forming the storage chambers 21, 22, and 23, an outer case 12 coupled to an outer side of the inner case 11, and a heat insulator 13 provided between the inner case 11 and the outer case 12. The inner case 11 may be formed of a plastic material, and the outer case 12 may be formed of a metal material. The heat insulator 13 may be provided using a urethane foam insulation, as needed together with a vacuum insulation panel. As the heat insulator 13 is foamed between the inner case 11 and the outer case 12, the inner case 11 and the outer case 12 may be coupled to each other. The main body 10 may have an intermediate wall 17 that divides the storage chambers 21, 22, and 23 in the upper to lower side direction.

The storage chambers 21, 22, and 23 may be used as a refrigerating chamber maintained at about 0° C. to 5° C. to store food refrigerated, and a freezing chamber maintained at about −30° C. to 0° C. to store food frozen.

The storage chambers 21, 22, and 23 may be provided with front sides that are open to allow food to be inserted or withdrawn therethrough, and the open front surfaces of the storage chambers 21, 22, and 23 may be opened and closed by the doors 30 and 40. The storage chambers 21, 22, and 23 may include a shelf 27 on which food may be placed and a storage container 28 for storing food.

The door 30 may be provided to open and close the first storage chamber 21. The door 30 may be coupled to the main body 10 so as to be rotatable in the left to right direction. In particular, the door 30 may be rotatably coupled to the outer case 12 of the main body 10. A door shelf 31 for storing food may be provided on a rear surface of the door 30.

The door 30 may include a gasket 32 provided to seal a gap between the door 30 and the main body 10 to prevent cold air of the first storage chamber 21 from leaking. The gasket 32 may be provided on the rear surface of the door 30. The gasket 32 may be formed along the circumference of the door 30 on the rear surface of the door 30. The gasket 32 may include rubber material and the like.

The door 30 includes a plurality of doors 30a and 30b, and the plurality of doors 30a and 30b may be disposed adjacent to each other. Specifically, the plurality of doors 30a and 30b may be disposed adjacent to each other in the left to right direction. Among the plurality of doors 30a and 30b, the door 30a disposed on the left side may be referred to as a first door 30a, and the door 30b disposed on the right side of the first door 30b may be referred to as a second door 30b. The naming of the first door 30a and the second door 30b is for the sake of convenience of description, and the configuration or function of the doors 30a and 30b is not limited by the names of such configurations.

The first door 30a may be rotatably coupled to the main body 10 to open and close at least a portion of the first storage chamber 21. The second door 30b may be rotatably coupled to the main body 10 to open and close at least another portion of the first storage chamber 21 that is not opened and closed by the first door 30a.

One of the doors 30 may have a rotating bar 100 that is rotatably mounted to cover a gap formed between the doors 30 in a closed state. In other words, the rotating bar 100 may be rotatably provided on the first door 30a or the second door 30b, and formed to cover a gap between the first door 30a and the second door 30b when the first door 30a and the second door 30b are closed.

In FIG. 1, the rotating bar 100 is illustrated as being rotatably coupled to the first door 30a, but the arrangement of the rotating bar 100 is not limited thereto as long as it is rotatably mounted on any one of the doors 30. For example, the rotating bar 100 may be rotatably coupled to the second door 30b unlike that shown in FIG. 1.

Hereinafter, for the sake of convenience of description, the rotating bar 100 may be described as being rotatably provided on the first door 30a of the doors 30, but as described above, the arrangement of the rotating bar 100 is not limited thereto.

The rotating bar 100 may be provided in a bar shape elongated along the height direction of the door 30, and may be rotated by a rotation guide 200 provided on the main body 10.

Specifically, when the first door 30a opens the first storage chamber 21, the rotating bar 100 may rotate to a first position in which the rotating bar 100 is disposed substantially perpendicular to the first door 30a. On the other hand, when the first door 30a closes the first storage chamber 21, the rotating bar 100 may rotate to a second position in which the rotating bar 100 is disposed substantially parallel to the first door 30a.

The doors 40 may be provided to be slidably inserted into or withdrawn from the second storage chamber 22 and the third storage chamber 23. The doors 40 may include a door portion 41 covering an open front side of the second storage chamber 22 and the third storage chamber 23 and a basket 43 coupled to a rear surface of the door portion 41. The basket 43 may be slidably supported by rails 45. A handle 41a may be provided on the door portion 41.

The cold air supply device may generate cold air using latent heat of evaporation of a refrigerant through a cooling cycle. The cold air supply device may include a compressor 2, a condenser, an expansion device, evaporators 3 and 4, and blowing fans 6 and 7.

The evaporators 3 and 4 may include a first evaporator 3 and a second evaporator 4.

The first evaporator 3 may be disposed at the rear of the first storage chamber 21 to generate cold air. The first evaporator 3 may be accommodated in a cooling chamber 3a formed by an evaporator cover 5. The evaporator cover 5 may be formed with an intake port 5a, and air may be drawn from the first storage chamber 21 into the cooling chamber 3a through the intake port 5a.

In the cooling chamber 3a, a first blowing fan 6 to flow air may be provided. The cooling chamber 3a may be formed with a cooling outlet 60 to discharge cold air from the cooling chamber 3a into the first storage chamber 21. With such a configuration, when the first blowing fan 6 operates, air may be drawn from the first storage chamber 21 into the cooling chamber 3a through the intake port 5a, and the drawn air may be cooled by passing through the first evaporator 3 and then discharged into the first storage chamber 21 through the cooling outlet 60.

The second evaporator 4 may be disposed at the rear of the third storage chamber 23 to generate cold air. The second evaporator 4 may be accommodated in a cooling chamber formed by an evaporator cover. The evaporator cover may be formed with an intake port, and air may be drawn from the third storage chamber 23 into the cooling chamber in which the second evaporator 4 is disposed through the intake port.

In the cooling chamber, a second blowing fan 7 to flow air may be provided. The cooling chamber may be formed with a cooling outlet to discharge cold air from the cooling chamber into the third storage chamber 23. With such a configuration, when the second blowing fan 7 operates, air may be drawn from the third storage chamber 23 into the cooling chamber through the intake port, and the drawn air may be cooled by passing through the second evaporator 4 and then discharged into the third storage chamber 23 through the cooling outlet.

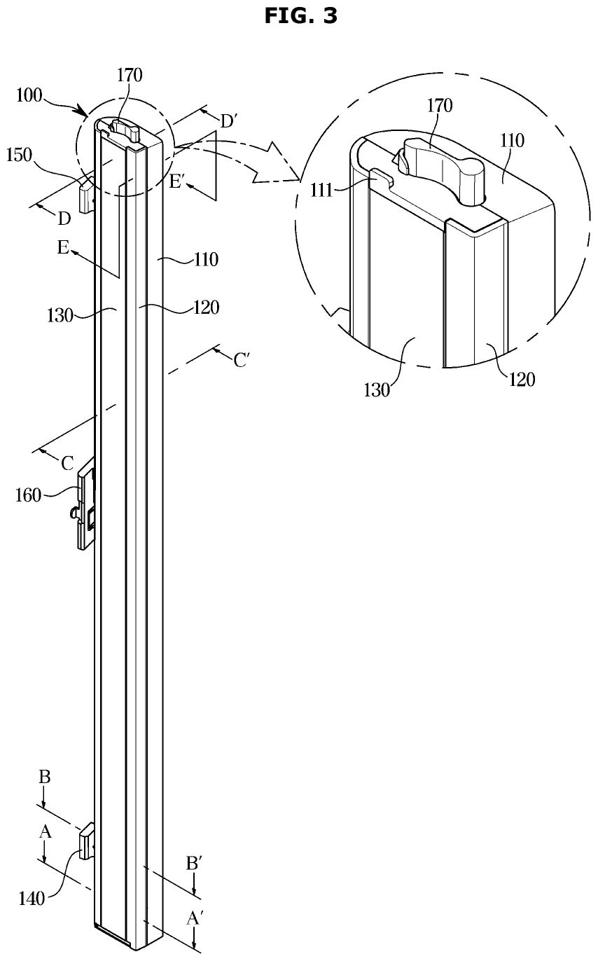

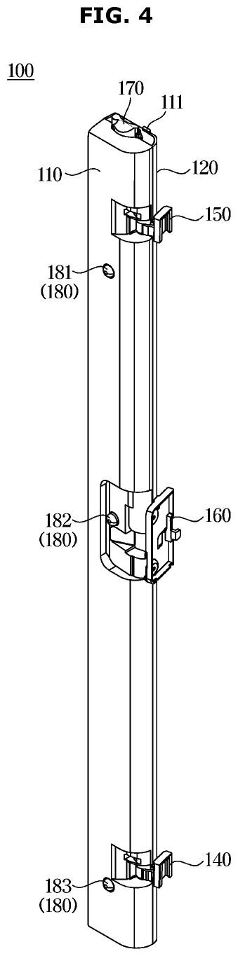

FIG. 3 is a view illustrating a rotating bar of a refrigerator according to an embodiment. FIG. 4 is a view illustrating the rotating bar shown in FIG. 3, when viewed at a different angle.

Referring to FIGS. 3 and 4, the rotating bar 100 according to an embodiment may include a case 110, a case cover 120 coupled to the case 110, a cover plate 130 coupled to the case cover 120, hinge members 140 and 150 coupled to the case 110 and the door 30 and configured to support the case 110 such that the case 110 rotates with respect to the door 30, and a guide protrusion 170 guided by the rotation guide 200 coupled to the main body 10. The hinge members 140 and 150 may include a lower hinge member 140 and an upper hinge member 150. The rotating bar 100 may include a wire cover member 160 provided to guide and cover a wire. The wire cover member 160 may be provided between the lower hinge member 140 and the upper hinge member 150. In other words, the wire cover member 160 may be provided in the middle of the rotating bar 100.

In the following description, among the hinge members 140 and 150, the lower hinge member 140 may be referred to as a first hinge member 140, and the upper hinge member 150 may be referred to as a second hinge member 150.

The case 110 may form the external appearance of the rotating bar 100 together with the case cover 120 and the cover plate 130. The case 110 may have one side that is open to accommodate hinge covers 145 and 155 and a guide cover 173 to be described below. The open side of the case 110 may be covered by the case cover 120 and the cover plate 130.

The case 110 may include a blocking rib 111 formed by a portion of a front end of an upper surface of the case 110 protruding upward. The blocking rib 111 may be provided to cover a guide groove (201 in FIG. 1) formed on the front surface of the rotation guide 200. The blocking rib 111 may cover the guide groove 201 to prevent air inside the storage chamber 21 from leaking through the guide groove 201.

The case cover 120 may be coupled to the open one side of the case 110 to cover the open one side of the case 110. The case 110 and the case cover 120 may include a plastic resin material. For example, the case 110 and the case cover 120 may include an acrylonitrile butadiene styrene copolymer (ABS) resin.

The cover plate 130 may be coupled to the case cover 120. Unlike the case 110 and the case cover 120, the cover plate 130 may include a metal material. A heat generating member may be provided between the cover plate 130 and the case cover 120. The heating member may prevent dew from forming on the cover plate 130 due to a temperature difference between the inside of the storage chamber 21 and the outside of the storage chamber 21.

The guide protrusion 170 may be provided to be inserted into the rotation guide 200 provided on the main body 10. The guide protrusion 170 may be guided by the rotation guide 200 during rotation of the door 30 to which the rotating bar 100 is coupled.

The case 110 may include a guide opening 112 that is formed to open in a portion of the upper surface of the case 110. The guide protrusion 170 may be protruded upward from the upper surface of the case 110 by passing through the guide opening 112. The guide protrusion 170 may be introduced to the inside of the case 110 by passing through the guide opening 112.

The guide protrusion 170 may be protruded upward from the upper surface of the case 110 by an elastic force of an elastic member 171. The guide protrusion 170 may be introduced into the case 110 when a force greater than or equal to an elastic force of the elastic member 171 is applied downward to the guide protrusion 170.

The guide protrusion 170 may be guided by the rotation guide 200 in a process of the door 30 being opened or closed, and thus introduced to the inside of the case 110 or protruded to the outside of the case 110 from the inside of the case 110. For example, in a process of the door 30 being closed, the guide protrusion 170 protruding outward of the case 110 may be inserted into the guide groove 201 of the rotation guide 200. While the door 30 is being closed, the guide protrusion 170 may be gradually introduced to the inside of the case 110 while moving along the guide groove 201. When the door 30 is completely closed, the guide protrusion 170 may be protruded to the outside of the case 110.

Alternatively, the guide protrusion may be provided not to be introduced to the inside of the case. In other words, the guide protrusion may be provided to remain protruded out of the case. In this case, an elastic member and a guide accommodating portion for accommodating the elastic member and the guide protrusion may not be provided. In addition, a guide protrusion may be provided on the main body, and a rotation guide may be provided on the rotating bar. Specifically, a guide groove may be provided on an upper surface of the rotating bar, and the main body may be provided with a guide protrusion formed to be inserted into the guide groove.

When one side of the rotating bar 100 on which the cover plate 130 and the case cover 120 are disposed are referred to as a front side of the rotating bar 100 for the sake of convenience of description, a buffer member 180 may be formed on a rear side of the rotating bar 100. The buffer member 180 may be protruded rearward from the rear surface of the rotating bar 100. When the rotating bar 100 comes in contact with the door 30, the buffer member 180 may alleviate noise and impact caused by contact or collision between the rotating bar 100 and the door 30. The buffer member 180 may be formed of a material capable of absorbing shock and noise. The buffer member 180 may include an upper buffer member 181, a middle buffer member 182, and a lower buffer member 183. However, the disclosure is not limited thereto, and the arrangement or number of buffer members may be changed.

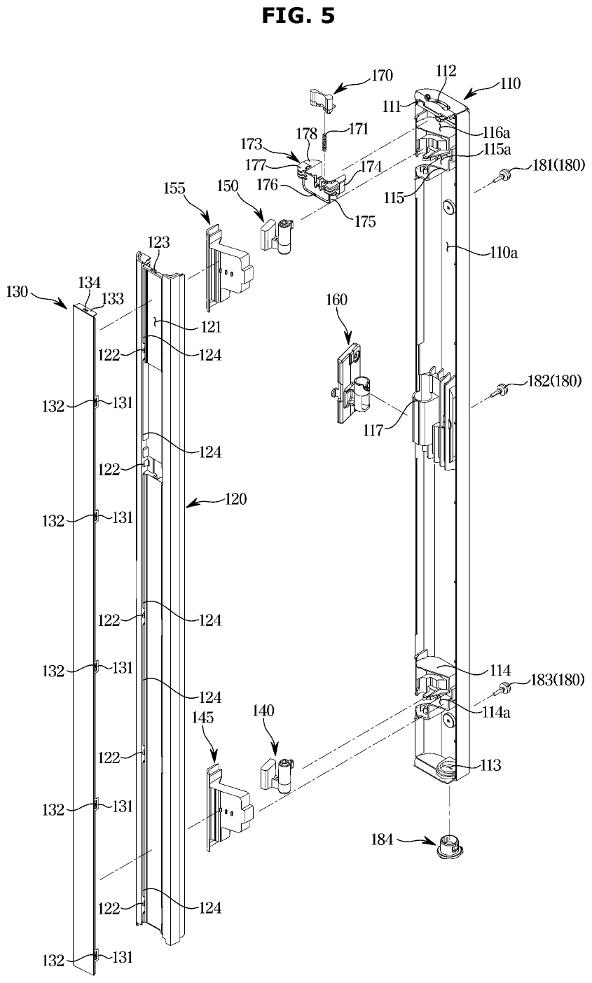

FIG. 5 is an exploded perspective view illustrating a rotating bar 100 according to an embodiment.

Referring to FIG. 5, the configuration of the rotating bar 100 according to an embodiment will be described in detail.

As described above, the rotating bar 100 may include the case 110 having a side that is open, the case cover 120, and the cover plate 130 provided to cover the open side of the case 110.

The case 110 may be coupled to the case cover 120 to form a heat insulating space 110a therein. A heat insulating member 190 may be accommodated in the heat insulating space 110a. In the present specification, the heat insulating space 110a may refer to an inner space.

The case 110 may include an injection hole 113 formed by an opening in at least a portion of a lower surface thereof. A foaming liquid forming the heat insulating member 190 may be injected through the injection hole 113. The injection hole 113 may be sealed by an injection hole cover 184.

The case 110 may include a first hinge partition wall 114 provided on a lower portion of the case 110. The first hinge partition wall 114 may form a first hinge accommodating portion 114a in which the first hinge member 140 is accommodated. The first hinge member 140 may be coupled to the first hinge accommodating portion 114a without a separate fastening member. The first hinge cover 145 may be coupled to the first hinge partition wall 114 to cover an open side of the first hinge accommodating portion 114a. Specifically, as the first hinge partition wall 114 is fitted into a cover groove 148 provided on a rear surface of the first hinge cover 145, the first hinge cover 145 may be coupled to the case 110.

The case 110 may include a second hinge partition wall 115 provided on an upper portion of the case 110. The second hinge partition wall 115 may form a second hinge accommodating portion 115a in which the second hinge member 150 is accommodated. The second hinge member 150 may be coupled to the second hinge accommodating portion 115a without a separate fastening member. The second hinge cover 155 may be coupled to the second hinge partition wall 115 to cover an one side of the second hinge accommodating portion 115a. Specifically, as the second hinge partition wall 115 is fitted into a cover groove provided on a rear surface of the second hinge cover 155, the second hinge cover 155 may be coupled to the case 110.

The first hinge member 140 and the second hinge member 150 may be provided to have the same structure. The first hinge partition wall 114 and the second hinge partition wall 115 may have the same structure. The first hinge accommodating portion 114a and the second hinge accommodating portion 115a may have the same structure. In addition, the first hinge cover 145 and the second hinge cover 155 may have the same structure.

The case 110 may include a cover member fixing portion 117 provided on a middle portion of the case 110. The wire cover member 160 may be coupled to the cover member fixing portion 117 without a separate fastening member.

The case 110 may include the blocking rib 111 formed by a portion of the front end of the upper surface of the case 110 being protruded upward. The blocking rib 111 may be provided to cover at least a portion of the guide groove (201 in FIG. 1) formed on the front surface of the rotation guide 200. As the blocking rib 111 may cover at least a portion of the guide groove 201, cold air discharged from the inside of the storage chamber 21 through the guide groove 201 may be blocked.

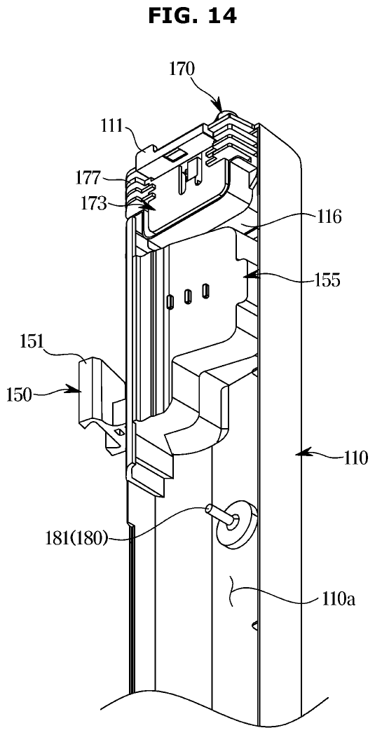

The case 110 may include a guide accommodating portion 116a provided on the upper side of the second hinge partition wall 115. The guide accommodating portion 116a may be formed inside of a guide partition wall (116 in FIG. 14). The guide accommodating portion 116a may accommodate the guide protrusion 170 and the elastic member 171.

The case cover 120 may include a plate coupling portion 121 on which the cover plate 130 is seated. The cover plate 130 may be coupled to the plate coupling portion 121. The case cover 120 may include first coupling protrusions 122 and support ribs 124 provided on both sides of the plate coupling portion 121. The case cover 120 may further include a second coupling protrusion 123 protruding upward from the upper surface of the case cover 120.

The first coupling protrusion 122 may be provided in plural. The plurality of first coupling protrusions 122 may be spaced apart from each other in the upper to lower direction in which the plate coupling portion 121 extends. The first coupling protrusions 122 may be provided on both sides of the plate coupling portion 121, respectively.

The support ribs 124 may be provided on both sides of the plate coupling portion 121, respectively. The support ribs 124 may be provided in plural. The plurality of support ribs 124 may be spaced apart from each other in the upper to lower direction in which the plate coupling portion 121 extends.

The cover plate 130 may be coupled to the plate coupling portion 121 of the case cover 120. The cover plate 130 may include a first protrusion accommodating portion 131 provided to accommodate the first coupling protrusion 122. In addition, the cover plate 130 may further include a second protrusion accommodating portion 133 provided to accommodate the second coupling protrusion 123.

The first protrusion accommodating portions 131 may be provided on both sides of the cover plate 130. The first protrusion accommodating portions 131 may protrude rearward from both side ends of the cover plate 130. The first protrusion accommodating portion 131 may include a first coupling protrusion accommodating hole 132 into which the first coupling protrusion 122 is inserted. The number of first protrusion accommodating portions 131 may correspond to the number of first coupling protrusions 122. The position of the first protrusion accommodating portion 131 may correspond to the position of the first coupling protrusion 122.

The second protrusion accommodating portion 133 may protrude rearward from the upper end of the cover plate 130. The second protrusion accommodating portion 133 may include a second protrusion accommodating hole 134 into which the second coupling protrusion 123 is inserted.

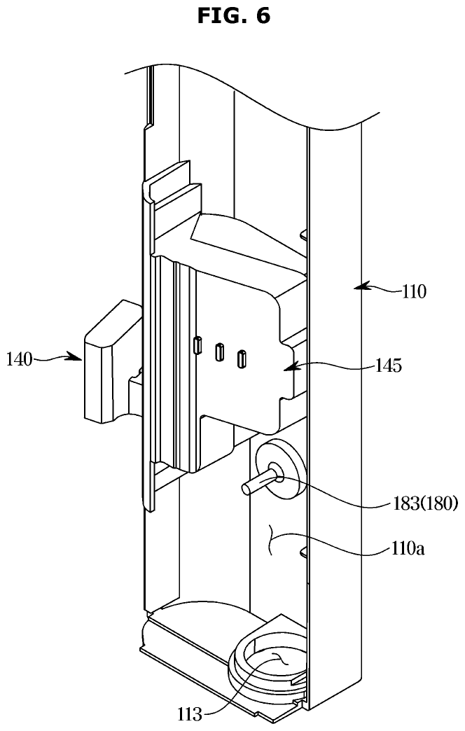

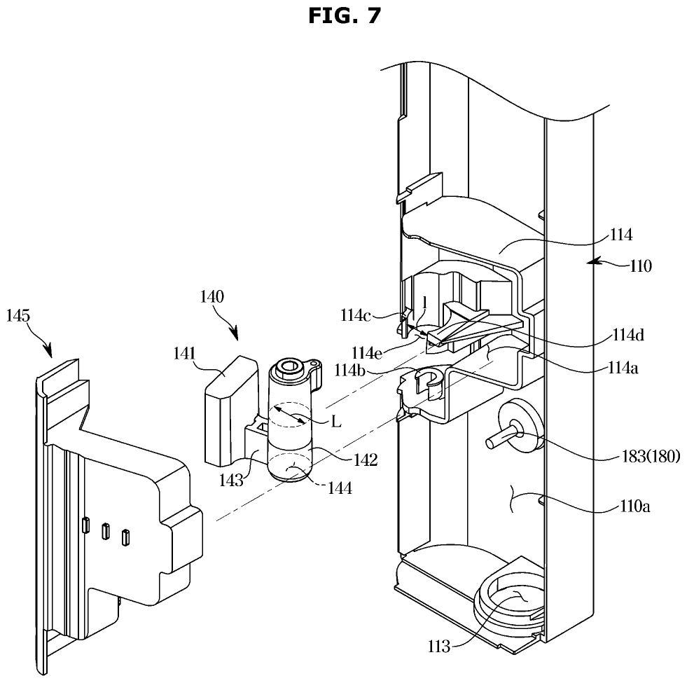

FIG. 6 is a view illustrating an inside of a lower portion of the rotating bar shown in FIG. 3. FIG. 7 is an exploded view of the rotating bar shown in FIG. 6.

According to an embodiment, after the rotating bar 100 is assembled, a foaming liquid forming the heat insulating member 190 may be foamed inside the rotating bar 100. In other words, after pre-assembly of the rotating bar 100, a foaming liquid may be injected into the rotating bar 100 through the injection hole 113 to form a heat insulating member.

According to an embodiment, the rotating bar 100 may be assembled only by elastic coupling or fitted coupling without using a separate fastening member. In addition, the rotating bar 100 may be pre-assembled, and then a foaming liquid is injected into the rotating bar 100 and cured to form the heat insulating member 190. The foaming liquid injected into the rotating bar 100 may not only form the heat insulating member 190 but may also serve as an adhesive that prevents separation of the rotating bar 100 assembled without a fastening member. With such a configuration, the types and number of parts and the number of assembling processes required when manufacturing the rotating bar may be reduced. In addition, since the time and cost required for manufacturing the rotating bar may also be reduced, productivity may be improved.

Referring to FIGS. 6 and 7, when a foaming liquid is injected into the rotating bar 100, the rotating bar 100 may prevent the foaming liquid from being introduced into the first hinge accommodating portion 114a in which the first hinge member 140 is accommodated.

The heat insulating space 110a formed inside the case 110 may have a foaming liquid injected through the injection hole 113 formed on a lower surface of the case 110. Since the foaming liquid hardens to form the heat insulating member 190, if the foaming liquid flows into the first hinge accommodating portion 114a in which the first hinge member 140 is accommodated, the first hinge member 140 may not rotate properly. Therefore, there is a need to block the inflow of a foaming liquid into the first hinge accommodating portion 114a.

Referring to FIG. 7, the case 110 may include the first hinge partition wall 114 that forms an outer edge of the first hinge accommodating portion 114a and serves as a partition wall that blocks the inflow of the foaming liquid. The first hinge partition wall 114 may form the first hinge accommodating portion 114a at an inside thereof. The first hinge accommodating portion 114a may be provided in a form with a side that is open. The first hinge cover 145 may be coupled to the first hinge partition wall 114 to cover the open side of the first hinge accommodating portion 114a. The first hinge cover 145 and the first hinge partition wall 114 may have corresponding shapes. With such a structure, the first hinge partition wall 114 is provided inside of the first hinge cover 145 such that the first hinge cover 145 and the first hinge partition wall 114 may be fitted and coupled to each other.

As the first hinge cover 145 is coupled to the first hinge partition wall 114, an inflow of a foaming liquid into the first hinge accommodating portion 114a formed inside of the first hinge cover 145 and the first hinge partition wall 114 may be blocked.

Referring to FIG. 7, the case 110 may include a support protrusion 114b inserted into the first hinge member 140 and rotatably supporting the first hinge member 140, and a first fixing protrusion 114c and a second fixing protrusion 114d provided to form a coupling space 114e, into which the first hinge member 140 is inserted, and elastically supporting the first hinge member 140.

The first hinge member 140 may include a door coupling portion 141 provided to be coupled to the door 30, a shaft portion 142 coupled to the first hinge accommodating portion 114a and serving as a rotation axis of the first hinge member 140, and a connecting portion 143 connecting the door coupling portion 141 and the shaft portion 142. The shaft portion 142 may be provided on a lower portion with a shaft hole 144 into which the support protrusion 114b is inserted. Alternatively, the shaft portion may be provided on a lower portion with a support protrusion, and the case may be provided with a shaft hole into which the support protrusion. In other words, the positions of the shaft hole of the shaft portion and the support protrusion of the case may be interchanged.

Referring to FIG. 7, a predetermined gap may be provided between the first fixing protrusion 114c and the second fixing protrusion 114d. A distance between the first fixing protrusion 114c and the second fixing protrusion 114d forming the predetermined gap is denoted as I. The diameter of the shaft portion 142 at one point passing through the predetermined gap is denoted as L. The diameter L of the shaft portion 142 at the one point may be greater than the distance I between the first fixing protrusion 114c and the second fixing protrusion 114d forming the predetermined gap.

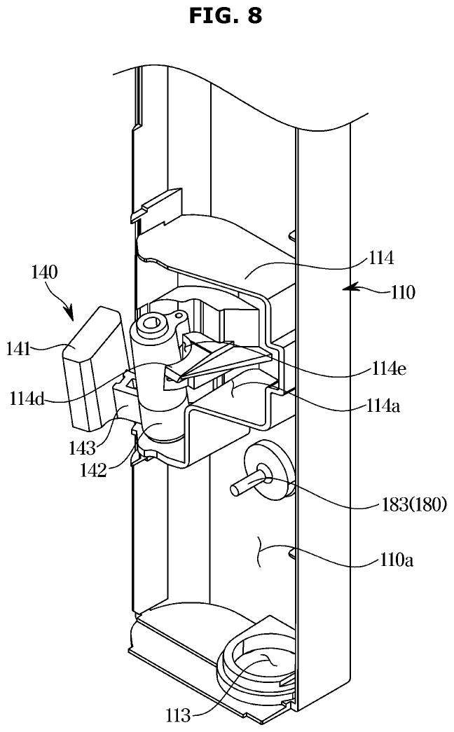

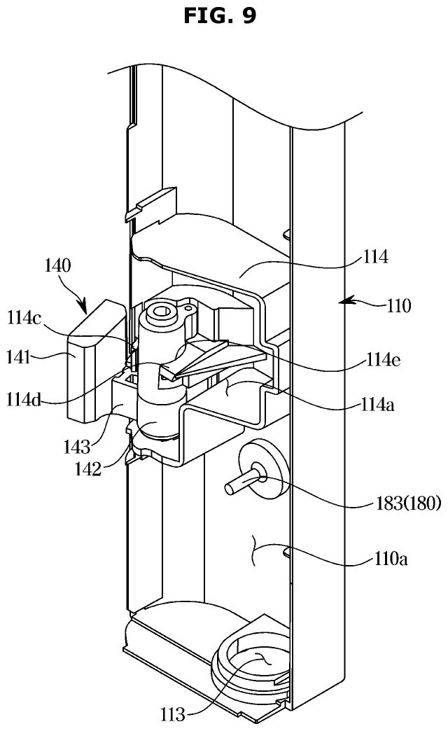

FIG. 8 is a view illustrating a process of coupling a lower hinge member to a case shown in FIG. 7. FIG. 9 is a view illustrating a state in which a lower hinge member is coupled to a case shown in FIG. 7.

Referring to FIGS. 8 and 9, the first hinge member 140 may be coupled to the inside of the first hinge accommodating portion 114a without a separate fastening member.

The first hinge member 140 may be coupled to the inside of the first hinge accommodating portion 114a by positioning the first hinge member 140 such that the support protrusion 114b is inserted into the shaft hole 144 of the shaft portion 142, and then rotating the shaft portion 142 for the shaft portion 142 is inserted into the coupling space 114e by passing through the gap between the first fixing protrusion 114c and the second fixing protrusion 114d. The shaft portion 142 may be inserted into the coupling space 114e by passing through the gap between the first fixing protrusion 114c and the second fixing protrusion 114d. As described above, since the diameter L of the shaft portion 142 at the one point is greater than the distance I between the first fixing protrusion 114c and the second fixing protrusion 114d forming the predetermined gap, the first fixing protrusion 114c and the second fixing protrusion 114d may be elastically deformed for the shaft portion 142 to pass through the gap between the first fixing protrusion 114c and the second fixing protrusion 114d. The shaft portion 142 inserted into the coupling space 114e by passing through the gap between the first fixing protrusion 114c and the second fixing protrusion 114d may be fixed by the first fixing protrusion 114c and the second fixing protrusion 114d, and thus prevented from being separated from the coupling space 114e.

Although the above description has been made in relation to the first hinge member 140, the first hinge partition wall 114, and the first hinge accommodating portion 114a, the second hinge member 150, the second hinge partition wall 115, and the second hinge accommodating portion 115a may have the same structure as the first hinge member 140, the first hinge partition wall 114, and the first hinge accommodating portion 114a. Redundant descriptions of the second hinge member 150, the second hinge partition wall 115, and the second hinge accommodating portion 115a will be omitted.

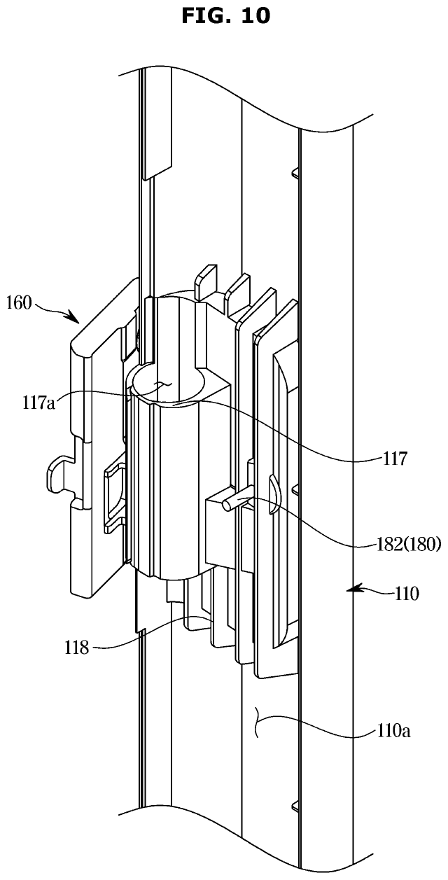

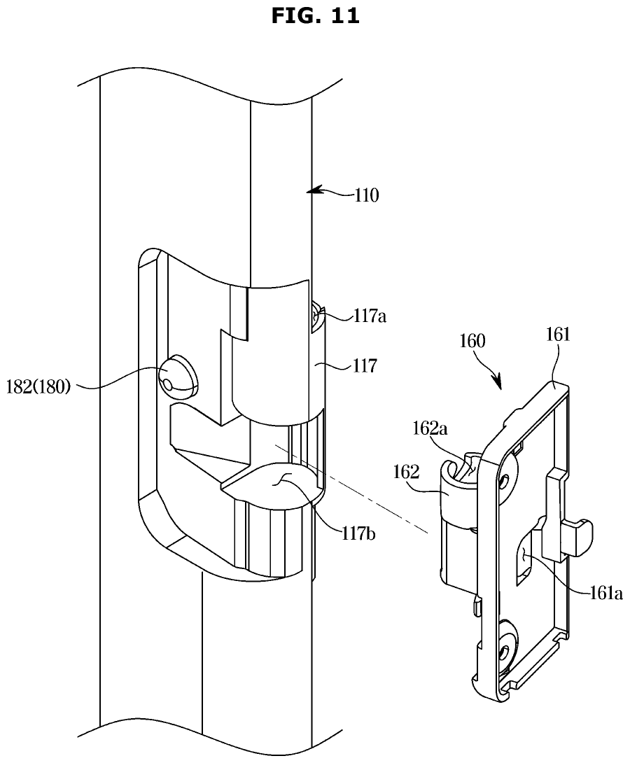

FIG. 10 is a view illustrating an inside of a middle portion of the rotating bar shown in FIG. 6. FIG. 11 is a view illustrating the rotating bar shown in FIG. 10, when viewed from a different angle, in a state in which a wire cover member is separated from a case.

Referring to FIG. 10, the wire cover member 160 may be coupled to the middle portion of the case 110. The case 110 may be provided in the middle portion thereof with a cover member fixing portion 117 and a first wire hole 117a formed by an opening in an upper surface of the cover member fixing portion 117. A wire may extend from the inside of the case 110 to the wire cover member 160 through the first wire hole 117a. A plurality of ribs extending in the upper to lower direction shown in the middle portion of the case 110 are reinforcing ribs 118 provided to reinforce the strength of the case 110.

The wire cover member 160 may include a door coupling portion 161 provided to be coupled to the door 30, a second wire hole 161a formed to pass through the door coupling portion 161 and provided to allow a wire to be withdrawn therethrough, and a rotating portion 162 serving as a rotating shaft of the wire cover member 160. The rotating portion 162 may include a third wire hole 162a passing through the rotating portion 162 in a direction in which a rotation axis of the rotating portion 162 extends. The rotating portion 162 may be inserted into a cover member accommodating space 117b provided on the rear surface of the case 110.

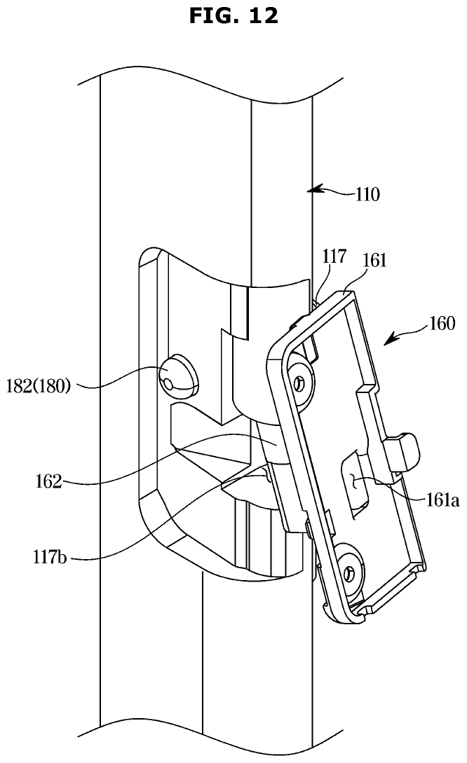

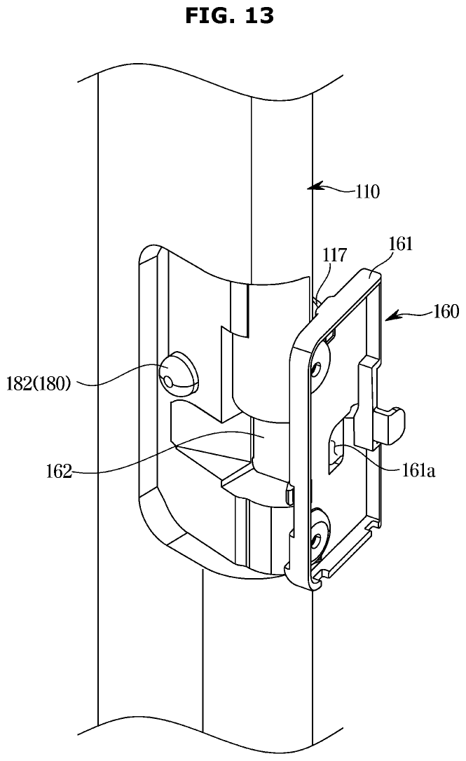

FIG. 12 is a view illustrating a process of coupling a wire cover member to the case shown in FIG. 11. FIG. 13 is a view illustrating a state in which a wire cover member is coupled to the case shown in FIG. 11.

Referring to FIGS. 12 and 13, the wire cover member 160 may be coupled to the case 110 without a separate fastening member. The wire cover member 160 may be coupled to the case 110 by being inserted into the cover member accommodating space 117b provided on the rear surface of the case 110. The wire cover member 160 may be coupled to the case 110 without a separate fastening member by inserting the rotating portion 162 into the cover member accommodating space 117b such that the rotating portion 162 is inserted into the first wire hole 117a. In a state in which the wire cover member 160 is coupled to the case 110, an upper portion of the rotating portion 162 may be placed within the first wire hole 117a. A lower portion of the rotating portion 162 may be placed within the cover member accommodating space 117b. A wire inside the case 110 may be extracted to the second wire hole 161a through the third wire hole 162a located inside the first wire hole 117a.

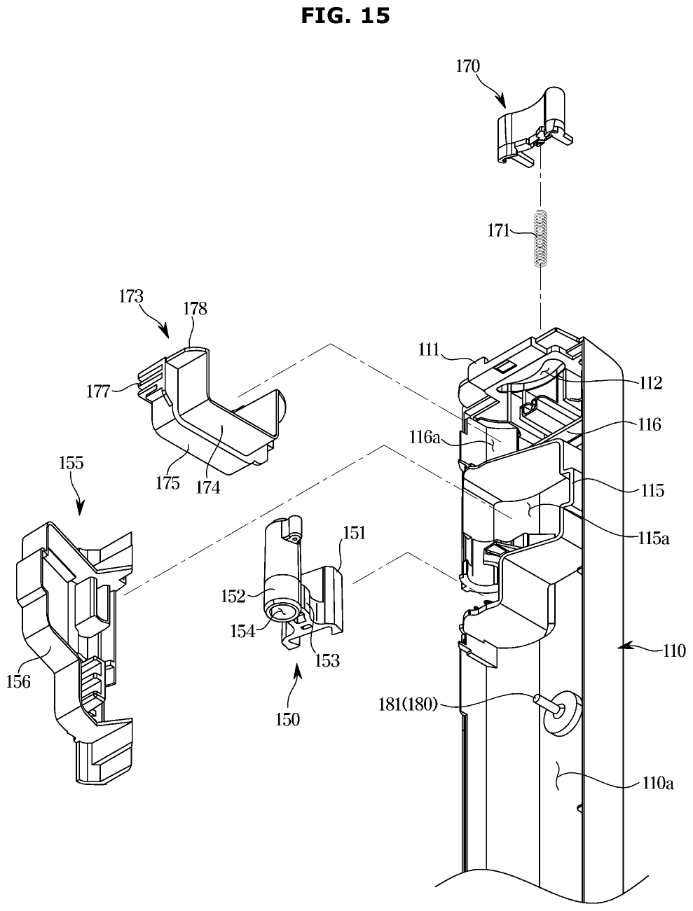

FIG. 14 is a view illustrating an inside of an upper portion of the rotating bar shown in FIG. 3. FIG. 15 is an exploded view illustrating the rotating bar shown in FIG. 14.

Referring to FIGS. 14 and 15, the second hinge member 150 may be coupled to the second hinge accommodating portion 115a formed inside of the second hinge partition wall 115 without a separate fastening member. Similar to the first hinge member 140, the second hinge member 150 may include a door coupling portion 151, a shaft portion 152, a shaft hole 154, and a connecting portion 153. Since the method and structure for coupling the second hinge member 150 to the second hinge accommodating portion 115a are the same as the method and structure for coupling the first hinge member 140 to the first hinge accommodating portion 114a, further description is omitted. In the second hinge cover 155, a cover rib 156 provided in a shape corresponding to the second hinge partition wall 115 is disposed to surround the second hinge partition wall 115, and the second hinge cover 155 may be fitted and coupled to the second hinge partition wall 115. As the second hinge cover 155 is coupled to the second hinge partition wall 115, an inflow of a foaming liquid into the second hinge accommodating portion 115a may be blocked.

The case 110 may include the guide accommodating portion 116a provided to accommodate the guide protrusion 170 and the elastic member 171. The guide accommodating portion 116a may be formed inside of the guide partition wall 116. The guide cover 173 may be provided to cover an open side of the guide accommodating portion 116a. The guide cover 173 may include a first rib 174 corresponding to the shape of the guide partition wall 116. As the first rib 174 is inserted into the outer side of the guide partition wall 116, the guide cover 173 may be coupled to the guide partition wall 116 without a separate fastening member. When the guide cover 173 is coupled to the guide partition wall 116, the inflow of a foaming liquid into the guide accommodating portion 116a may be blocked. Detailed structure thereof is described below.

In the guide accommodating portion 116a formed inside of the guide cover 173 and the guide partition wall 116, the guide protrusion 170 and the elastic member 171 may be disposed. The elastic member 171 may provide elastic force to the guide protrusion 170 such that the guide protrusion 170 protrudes upward from the upper surface of the case 110 by passing through the guide opening 112 of the case 110.

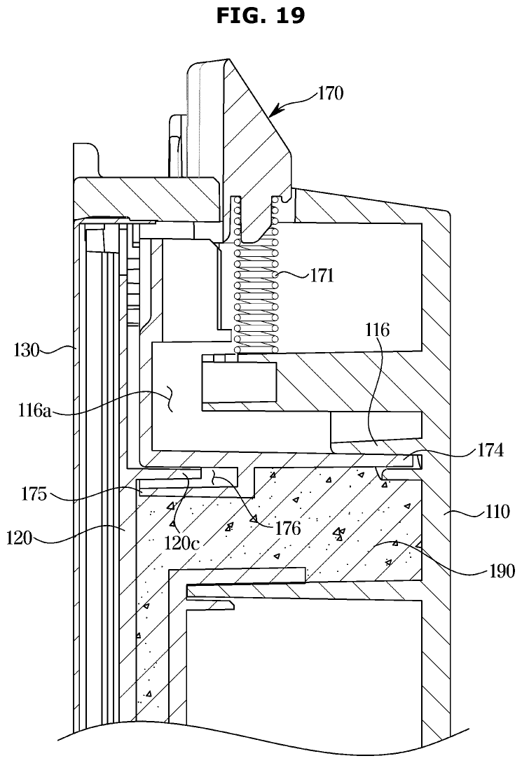

The guide cover 173 may further include a second rib 175 provided in parallel with the first rib 174, and a coupling groove (176 in FIGS. 5 and 19) formed between the first rib 174 and the second rib 175. The second rib 175 and the coupling groove 176 are described below.

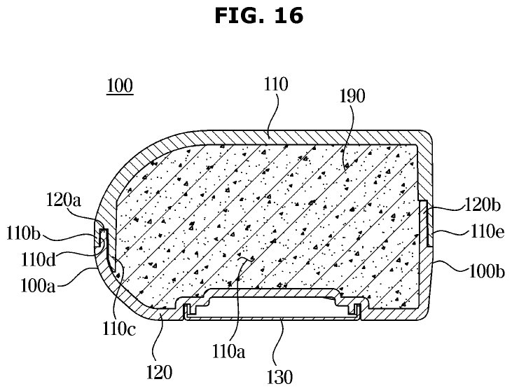

FIG. 16 is a cross-sectional view taken along a line A-A″ in FIG. 3.

According to an embodiment, the case 110 and the case cover 120 may be attached to each other by a foaming liquid. The case 110 and the case cover 120 may be coupled to each other by a protrusion and groove structure to be described below without a separate tool or fastening member. The case 110 and the case cover 120 may be assembled by a protrusion and groove structure, but may be separable. In a state in which the case 110 and the case cover 120 are assembled, a foaming liquid may be injected into the heat insulating space 110a, which is an inner space between the case 110 and the case cover 120, and then cured, and thus the heat insulating member 190 may be formed in the heat insulating space 110a. The foaming liquid injected into the heat insulating space 110a may function as an adhesive such that the case 110 and the case cover 120 may not be separated from each other. Therefore, after the formation of the heat insulating member 190, the case 110 and the case cover 120 coupled to each other by the heat insulating member 190 may be prevented from being separated from each other.

Based on FIG. 16, one side 100a and the other side 100b of the rotating bar 100 may be defined. When the rotating bar 100 is in a first position in which the rotating bar 100 is substantially perpendicular to the door 30, the one side 100a of the rotating bar 100 may be arranged to face the outside of the storage chamber 21, and the other side 100b of the rotating bar 100 may be arranged to face the inside of the storage chamber 21. Due to the arrangement, when the door 30 is opened, the one side 100a of the rotating bar 100 may be located in the user's visible area, and the other side 100b of the rotating bar 100 may not be located in the user's visible area.

According to an embodiment, on the one side 100a of the rotating bar 100, the case 110 and the case cover 120 may be prevented from being separated from each other by a foaming stress of the foaming liquid. To this end, the case or case cover may include an insertion protrusion, and the case cover or case may include an insertion groove into which the insertion protrusion is inserted. For example, as shown in FIG. 16, the case cover 120 may include an insertion protrusion 120a, and the case 110 may include an insertion groove 110d into which the insertion protrusion 120a may be inserted. The insertion groove 110d may be formed between the first protrusion 110b and the second protrusion 110c provided on a side of the case 110.

When the insertion protrusion 120a is inserted into the insertion groove 110d, the insertion protrusion 120a may be constrained by the first protrusion 110b and the second protrusion 110c. Since the insertion protrusion 120a is constrained by the first protrusion 110b and the second protrusion 110c, even when the foaming stress of the foaming liquid is applied, the insertion protrusion 120a may be prevented from being withdrawn from the insertion groove 110d. With such a configuration, the case 110 and the case cover 120 may be prevented from being spaced from each other and forming a gap on the one side 100a of the rotating bar 100. Since the one side 100a of the rotating bar 100 exposed to the user does not have a gap, the finishing reliability of the product may be improved.

On the other side 100b of the rotating bar 100, a pair of protrusion structures may be provided. For example, the case 110 may include a third protrusion 110e protruding toward the case cover 120, and the case cover 120 may include a fourth protrusion 120b provided to engage with the third protrusion 110e. However, the disclosure is not limited thereto, and a protrusion and groove structure may be provided on the other side 100b of the rotating bar, similar to the side 100a of the rotating bar.

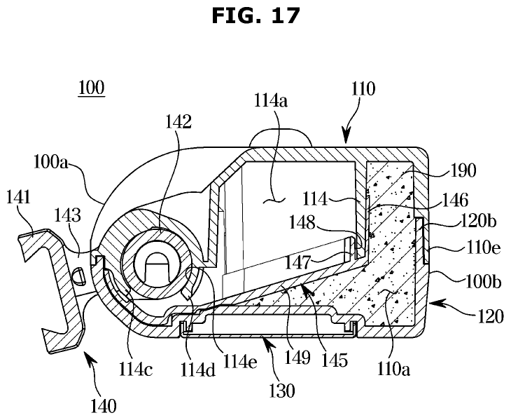

FIG. 17 is a cross-sectional view taken along line B-B′ in FIG. 3.

Referring to FIG. 17, the first hinge cover 145 includes a first cover protrusion 146, a second cover protrusion 147, and a cover groove 148 formed between the first cover protrusion 146 and the second cover protrusion 147. The first hinge partition wall 114 may be inserted into the cover groove 148. With such a structure, an inflow of the foaming liquid in the heat insulating space 110a from the heat insulating space 110a to the inside of the first hinge accommodating portion 114a may be blocked. In order for the foaming liquid to flow into the first hinge accommodating portion 114a, the foaming liquid needs to pass through all of the first cover protrusion 146, the first hinge partition wall 114, and the second cover protrusion 147. As the inflow path of a foaming liquid into the first hinge accommodating portion 114a is complicated, an inflow of the foaming liquid into the first hinge accommodating portion 114a through the first cover protrusion 146, the first hinge partition wall 114, and the second cover protrusion 147 may be blocked.

Referring to FIG. 17, the first hinge cover 145 may include an inclined surface 149 obliquely extending from an end of the first cover protrusion 146 toward the first hinge member 140. The inclined surface 149 may be provided such that the distance between the inclined surface 149 and the case cover 120 decreases in a direction from the first cover protrusion 146 to the first hinge member 140. The inclined surface 149 may guide the foaming liquid such that the foaming liquid is evenly filled inside the heat insulating space 110a. By moving along the inclined surface 149, the foaming liquid may evenly fill the narrow space between the inclined surface 149 and the case cover 120.

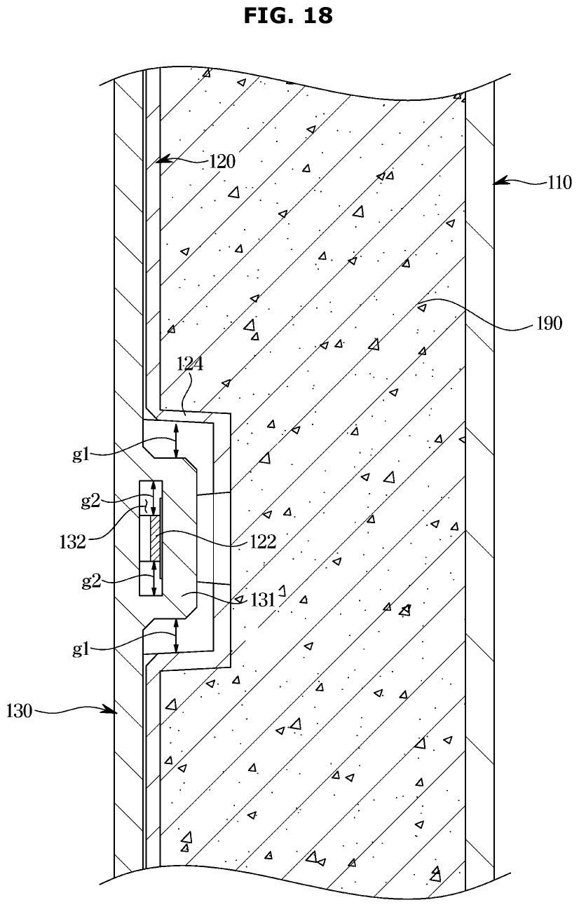

FIG. 18 is a cross-sectional view taken along line C-C′ of FIG. 3.

Referring to FIG. 18, bending of the rotating bar 100 due to a difference in linear expansion coefficients between the cover plate 130 formed of a metal material and the case cover 120 formed by an injection molding or formed of a resin material may be prevented.

As described above, in the rotating bar 100 according to the embodiment the components may be pre-assembled, and a high-temperature foaming liquid may be injected through the injection hole 113 and then cured to form the heat insulating member 190 inside the rotating bar 100.

When the high-temperature foaming liquid is foamed inside the rotating bar 100, the cover plate 130 formed of a metal material may expand more than the case cover 120 formed by an injection molding or formed of a resin material. Conversely, when the rotating bar 100 is disposed inside the storage chamber 21 having a low-temperature, the cover plate 130 may contract more than the case cover 120. This is because the linear expansion coefficient of the cover plate 130 formed of a metal material is greater than that of the case cover 120 formed by an injection molding or formed of a resin material. Due to the difference in linear expansion coefficients, the rotating bar 100 may be bent. For example, when the foaming liquid is injected, the cover plate 130 may expand more than the case cover 120, and thus the rotating bar 100 may be bent. When the rotating bar 100 is placed inside the storage chamber 21 after the foaming liquid is cured, the cover plate 130 may contract more than the case cover 120, and thus the rotating bar 100 may be bent.

In order to prevent a bending of the rotating bar 100, the cover plate 130 may include the first protrusion accommodating portion 131 and the first protrusion accommodating hole 132 formed to pass through the first protrusion accommodating portion 131. The case cover 120 may include the first coupling protrusion 122 provided to be inserted into the first protrusion accommodating hole 132 and the support ribs 124 extending at both sides of the first coupling protrusion 122.

In order to prevent a bending of the rotating bar 100 due to a difference in linear expansion coefficients between the cover plate 130 and the case cover 120, the first protrusion accommodating hole 132 may be provided larger than the first coupling protrusion 122, and the support ribs 124 may be provided to be spaced apart from both side ends of the first protrusion accommodating portion 131 by a predetermined distance. Specifically, a predetermined gap g1 may be formed between one side end of the first protrusion accommodating portion 131 and the support rib 124 adjacent to the one side end. Similarly, a predetermined gap g1 may be formed between the other side end of the first protrusion accommodating portion 131 and the support rib 124 adjacent to the other side end. In addition, a predetermined gap g2 may be formed from one side end of the first coupling protrusion 122 inserted into the first protrusion accommodating hole 132 to one side end of the first protrusion accommodating hole 132. A predetermined gap g2 may be formed from the other side end of the first coupling protrusion 122 inserted into the first protrusion accommodating hole 132 to the other end of the first protrusion accommodating hole 132. Due to the structure, even when the cover plate 130 having a great linear expansion coefficient expands or contracts more than the case cover 120, the first coupling protrusion 122 may be located in the first protrusion accommodating hole 132, and the first protrusion accommodating portion 131 may neither contact the support rib 124 nor physically deform the support rib 124.

FIG. 19 is a cross-sectional view taken along line D-D′ in FIG. 3.

Referring to FIG. 19, the inflow of a foaming liquid into the guide accommodating portion 116a formed inside of the guide partition wall 116 may be blocked. The first rib 174 of the guide cover 173 may be disposed outside of the guide partition wall 116. The first rib 174 may be inserted into a groove formed between the guide partition wall 116 and a predetermined protrusion provided on the outside of the guide partition wall 116. As described above, such a protrusion and groove structure may block the inflow of the foaming liquid and thus prevent the foaming liquid from flowing into the guide accommodating portion 116a by passing through the first rib 174 and the guide partition wall 116.

The guide cover 173 may further include the second rib 175 disposed to be spaced apart outward from the first rib 174 by a predetermined distance, and the coupling groove 176 formed between the first rib 174 and the second rib 175. A fifth protrusion 120c of the case cover 120 may be inserted into the coupling groove 176. The second rib 175, the fifth protrusion 120c, and the first rib 174 may form the above-described protrusion and groove structure. Therefore, the inflow of the foaming liquid into the guide accommodating portion 116a via the second rib 175, the fifth protrusion 120c, and the first rib 174 may be blocked.

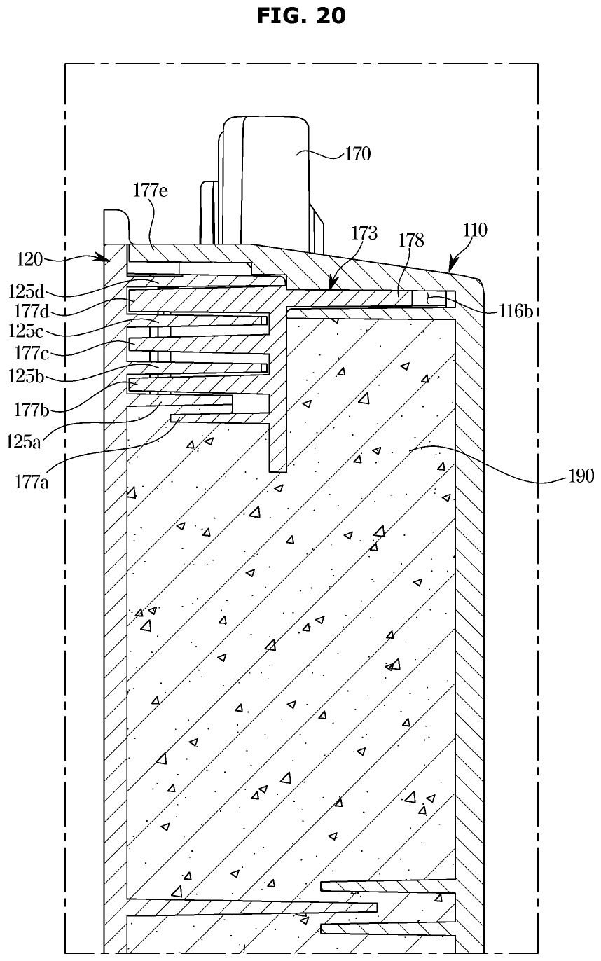

FIG. 20 is a cross-sectional view taken along line E-E′ in FIG. 3.

Referring to FIG. 20, a plurality of partition walls and a plurality of grooves may be provided on the upper end of the rotating bar 100 to prevent leakage of the foaming liquid.

As described above, the injection hole 113 may be provided on the lower surface of the rotating bar 100. When a foaming liquid is injected into the injection hole 113, the rotating bar 100 may be disposed such that the injection hole 113 faces upward. When a foaming liquid is injected into the injection hole 113 by disposing the rotating bar 100 to be inverted in an upside-down fashion, the foaming liquid may flow in the direction of gravity due to gravity. The foaming liquid may flow in the direction of gravity and fill the heat insulating space 110a.

In order to prevent a leakage of the foaming liquid, a plurality of partition walls and a plurality of grooves may be provided as shown in FIG. 20.

For example, the case 110 may include a partition wall groove 116b into which a blocking partition wall 178 of the guide cover 173 is inserted. As the blocking partition wall 178 is inserted into the partition wall groove 116b, the blocking partition wall 178 and the partition wall groove 116b may prevent the foaming liquid from leaking through the blocking partition wall 178 and the partition wall groove 116b.

Similarly, the guide cover 173 may include a plurality of partition walls, and the case cover 120 may also include a plurality of partition walls, to prevent a leakage of the foaming liquid between the guide cover 173 and the case cover 120.

For example, the guide cover 173 may include a first blocking partition wall 177a, a second blocking partition wall 177b, a third blocking partition wall 177c, a fourth blocking partition wall 177d, and a fifth blocking partition wall 177e formed consecutively in the vertical direction.

The case cover 120 may include a sixth blocking partition 125a inserted between the first blocking partition 177a and the second blocking partition 177b, a seventh blocking partition 125b inserted between the second blocking partition 177b and the third blocking partition 177c, an eighth blocking partition 125c inserted between the third blocking partition 177c and the fourth blocking partition 177d, and a ninth blocking partition wall 125d inserted between the fourth blocking partition 177d and the fifth blocking partition 177e.

Since the first to ninth blocking barrier ribs 177a, 177b, 177c, 177d, 177e, 125a, 125b, 125c, and 125d complicate the moving path of the foaming liquid, a leakage of the foaming liquid may be prevented.

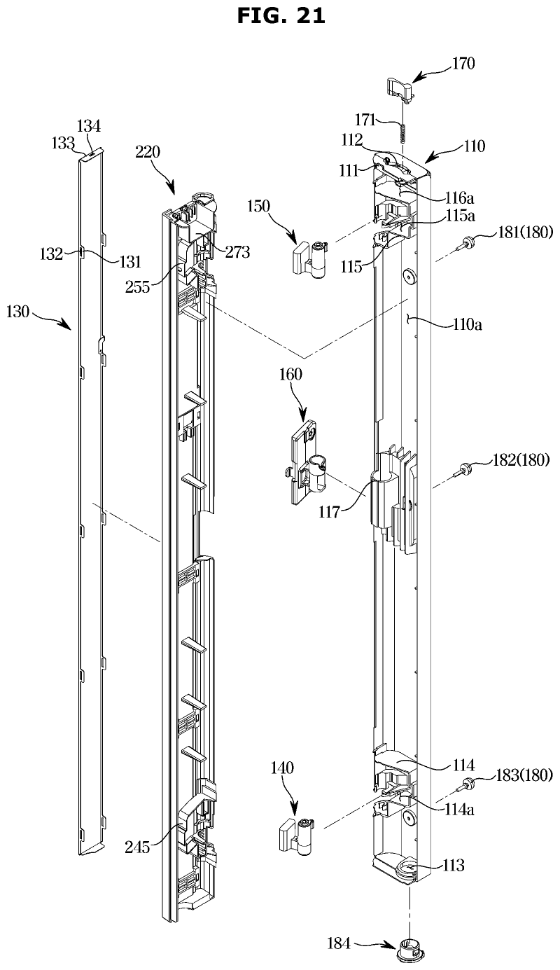

FIG. 21 is an exploded perspective view illustrating a rotating bar in a refrigerator according to an embodiment.

Referring to FIG. 21, in a refrigerator according to an embodiment, a case cover 220 may be integrally formed with a guide cover 273, a first hinge cover 245, and a second hinge cover 255. As the case cover 220 is integrally formed with the guide cover 273, the first hinge cover 245, and the second hinge cover 255, the assembly process of the rotating bar may be simplified, and the number of parts of the rotating bar may decrease. Thus, the productivity of the rotating bar may be improved, and the production cost may be reduced. The case cover may be integrally formed with the guide cover, the first hinge cover, and the second hinge cover, or the case cover may be integrally formed with at least one of the guide cover, the first hinge cover, and the second hinge cover.

According to an embodiment, a refrigerator includes: a main body forming a storage chamber; a first door rotatably coupled to the main body to open and close at least a portion of the storage chamber; a second door laterally disposed to the first door and rotatably coupled to the main body to open and close at least another portion of the storage chamber; and a rotating bar rotatably provided with respect to the first door, and configured to cover a gap between the first door and the second door when the first door and the second door are closed,

The rotating bar may include: a case; a case cover coupled to the case to form an inner space together with the case; and a foaming liquid foamed in the inner space to form a heat insulator in the inner space and configured to couple the case and the case cover to prevent the case and the case cover from being separated from each other.

The case may include an injection hole formed on a lower surface of the case and through which the foaming liquid is injected.

The rotating bar may further include a hinge member including a door coupling portion coupled to the first door and a shaft portion coupled to the case to be rotatable with respect to the case, the hinge member configured to allow the case to be rotatable with respect to the first door.

The case may include a first fixing protrusion and a second fixing protrusion provided to fix the shaft portion together with the first fixing protrusion.

A predetermined gap may be formed between the first fixing protrusion and the second fixing protrusion.

A distance between the first fixing protrusion and the second fixing protrusion forming the predetermined gap may be formed to be smaller than a diameter of the shaft portion.

The hinge member may be coupled to the case as the shaft portion passes through the predetermined gap by deforming the first fixing protrusion and the second fixing protrusion.

The case may include a hinge partition wall protruding from the case toward the case cover and configured to partition the inner space.

The rotating bar may further include a hinge cover coupled to the hinge partition wall to form a hinge accommodating portion that accommodates the hinge member together with the hinge partition wall.

The hinge cover may include: a first protrusion and a second protrusion protruding toward the hinge partition wall; and a cover groove formed between the first protrusion and the second protrusion to accommodate the hinge partition wall.

As the hinge partition wall is accommodated in the cover groove, the hinge cover may be coupled to the hinge partition wall.

While the hinge cover is coupled to the hinge partition wall, the first protrusion, the hinge partition wall, and the second protrusion may be configured to block the foaming liquid injected into the inner space from flowing into the hinge accommodating portion.

The rotating bar may further include a cover plate formed of a metal material.

The case cover may include: a plate coupling portion configured to seat the cover plate thereon; a coupling protrusion formed on the plate coupling portion; AND a support rib formed to be spaced apart from the coupling protrusion and configured to support the cover plate.

The cover plate may include: a protrusion accommodating portion protruding from the cover plate toward the case cover, the protrusion accommodating portion configured to be coupled to the coupling protrusion; and a protrusion accommodating hole formed in the protrusion accommodating portion and into which the coupling protrusion may be inserted.

The protrusion accommodating hole may be configured to have a predetermined gap with respect to both side ends of the coupling protrusion to accommodate the coupling protrusion therein in response to the cover plate beings contracted.

The protrusion accommodating portion may be configured to have a predetermined gap with respect to the support rib to prevent a contact with the support rib in response to the cover plate being expanded.

The rotating bar may further include a guide protrusion formed to protrude upward from an upper surface of the rotating bar.

The main body may include a guide groove formed to guide the guide protrusion during opening of the first door, to which the rotating bar may be coupled.

The rotating bar may further include a blocking rib formed to protrude upward from an upper surface of the case, and disposed apart from the guide protrusion.

The blocking rib may be configured to cover at least a portion of the guide groove to disperse cold air discharged from the storage chamber through the guide groove.

Although the disclosure has been shown and described in relation to specific embodiments, it would be appreciated by those skilled in the art that changes and modifications may be made in these embodiments without departing from the principles and scope of the disclosure, the scope of which is defined in the claims and their equivalents.

What is claimed is:

1. A refrigerator comprising:
a main body forming a storage chamber;
a first door rotatably coupled to the main body to open and close at least a portion of the storage chamber;
a second door adjacent to the first door and rotatably coupled to the main body to open and close at least another portion of the storage chamber; and
a rotating bar rotatably coupled to the first door and configured to cover a gap between the first door and the second door when the first door and the second door are closed,
wherein the rotating bar comprises:
a case;
a case cover coupled to the case, the case cover and the case together forming an inner space; and
a foamed heat insulator disposed in the inner space and couples the case and the case cover to each other.

2. The refrigerator of claim 1, wherein the case comprises an injection hole provided on a lower surface of the case and configured to receive a foaming liquid that is injected therein to form the foamed heat insulator.

3. The refrigerator of claim 1, wherein the rotating bar further comprises a hinge member,
wherein the hinge member comprises a door coupling portion coupled to the first door and a shaft portion rotatably coupled to the case,
wherein the rotating bar is rotatably coupled to the first door via the hinge member, and
wherein the case comprises a first fixing protrusion and a second fixing protrusion, the shaft portion is coupled to the first fixing protrusion and the second fixing protrusion, and a gap is formed between the first fixing protrusion and the second fixing protrusion.

4. The refrigerator of claim 3, wherein the gap is smaller than a diameter of the shaft portion, and
wherein the hinge member is coupled to the case as the shaft portion passes through the gap by deforming the first fixing protrusion and the second fixing protrusion.

5. The refrigerator of claim 3, wherein the case further comprises a hinge partition wall protruding from the case toward the case cover and configured to partition the inner space, and
wherein the rotating bar further comprises a hinge cover coupled to the hinge partition wall to form a hinge accommodating portion that accommodates the hinge member.

6. The refrigerator of claim 5, wherein the hinge cover comprises:
a first protrusion protruding toward the hinge partition wall;
a second protrusion protruding toward the hinge partition wall; and
a cover groove between the first protrusion and the second protrusion,
wherein the hinge partition wall is accommodated in the cover groove,
wherein the foamed heat insulator is introduced into the inner space as a foaming liquid, and
wherein the first protrusion, the hinge partition wall, and the second protrusion are configured to block the foaming liquid from flowing into the hinge accommodating portion.

7. The refrigerator of claim 1, wherein the rotating bar further comprises a cover plate formed of a metal material,
wherein the case cover comprises:
a plate coupling portion;
a coupling protrusion on the plate coupling portion; and
a support rib spaced apart from the coupling protrusion and configured to support the cover plate, and
wherein the cover plate is seated in the plate coupling portion.

8. The refrigerator of claim 7, wherein the cover plate further comprises a protrusion accommodating portion which comprises a protrusion accommodating hole, and
wherein the protrusion accommodating portion protrudes from the cover plate toward the case cover and the coupling protrusion is inserted into the protrusion accommodating hole.

9. The refrigerator of claim 8, wherein a gap exists between an inner edge of the protrusion accommodating hole and each of a first side end and a second side end of the coupling protrusion.

10. The refrigerator of claim 8, wherein a gap exists between an outer edge of the protrusion accommodating portion and the support rib.

11. The refrigerator of claim 1, wherein the rotating bar further comprises a guide protrusion protruding upward from an upper surface of the rotating bar, and
wherein the main body comprises a guide groove configured to guide the guide protrusion during opening of the first door.

12. The refrigerator of claim 11, wherein the rotating bar further comprises a blocking rib protruding upward from an upper surface of the case and disposed apart from the guide protrusion, and
wherein the blocking rib is configured to cover at least a portion of the guide groove to prevent discharge of air from the storage chamber through the guide groove.

13. A refrigerator comprising:
a first door;
a second door; and
a rotating bar rotatably coupled to the first door and configured to cover a gap between the first door and the second door when the first door and the second door are closed,
wherein the rotating bar comprises a case and a case cover together forming an inner space, and a foamed heat insulator disposed in the inner space, and
wherein the foamed heat insulator couples the case and the case cover to each other and is introduced into the inner space as a foaming liquid.

14. The refrigerator of claim 13, wherein the rotating bar further comprises a hinge member coupled to the first door, and
wherein the rotating bar is rotatably coupled to the first door via the hinge member.

15. The refrigerator of claim 14, wherein the rotating bar further comprises:
a hinge partition wall disposed in the inner space and configured to partition the inner space; and
a hinge cover in the inner space and coupled to the hinge partition wall,
wherein the hinge partition wall and the hinge cover form a hinge accommodating portion, and
wherein the hinge member is disposed in the hinge accommodating portion.

16. The refrigerator of claim 15, wherein the hinge accommodating portion is configured to prevent the foaming liquid from entering the hinge accommodating portion when the foaming liquid is introduced into the inner space.

17. A rotating bar of a refrigerator, the rotating bar comprising:
a case;
a case cover coupled to the case, wherein the case and the case cover together form an inner space;
a foamed heat insulator disposed within the inner space and configured to couple the case and the case cover to each other; and
a hinge member configured to be rotatably coupled to a door of the refrigerator,
wherein the foamed heat insulator is introduced into the inner space as a foaming liquid.

18. The rotating bar of claim 17 further comprising:
a hinge partition wall disposed within the inner space and configured to partition the inner space; and
a hinge cover in the inner space and coupled to the hinge partition wall,
wherein the hinge partition wall and the hinge cover form a hinge accommodating portion, and
wherein the hinge member is disposed within the hinge accommodating portion.

19. The rotating bar of claim 18, wherein the hinge accommodating portion is configured to prevent the foaming liquid from entering the hinge accommodating portion when the foaming liquid is introduced into the inner space.

20. The rotating bar of claim 18, wherein the hinge cover comprises:
a first protrusion protruding toward the hinge partition wall;
a second protrusion protruding toward the hinge partition wall; and
a cover groove formed between the first protrusion and the second protrusion to accommodate the hinge partition wall, and
wherein the hinge partition wall is accommodated in the cover groove, and
wherein the first protrusion, the hinge partition wall, and the second protrusion are configured to block the foaming liquid from flowing into the hinge accommodating portion.
